(19) United States
(12) Patent Application Publication
(10) Pub. No.: US 2012/0163263 A1
(43) Pub. Date: Jun. 28, 2012

(54) BASE STATION, TERMINAL, AND OPERATING METHOD THEREOF

(75) Inventors: Mi Kyung OH, Gyeongju-si (KR); Young Ae JEON, Daejeon (KR); cheol-ho SHIN, Daejeon (KR); Seung Sik LEE, Daejeon (KR); Sangjae LEE, Daejeon (KR); Byoung Hak KIM, Daejeon (KR); Sangsung CHOI, Daejeon (KR)

(73) Assignee: Electronics and Telecommunications Research Institute, Daejeon (KR)

(21) Appl. No.: 13/335,530

(22) Filed: Dec. 22, 2011

(30) Foreign Application Priority Data
Dec. 22, 2010 (KR) 10-2010-0132714

(51) Int. Cl. H04W 52/02

(52) U.S. Cl. 370/311

(57) ABSTRACT

A base station and a terminal for supporting a low power mode are provided. The base station transmits a first type of beacon signal for a terminal operating in a normal mode, a second type of beacon signal for a terminal operating in a low power mode, and a charging signal for a terminal in a low power mode. The terminal harvests energy from a charging signal and receives the second type of beacon signal using the harvested energy. The terminal confirms a communication request through the second type of beacon signal, enters into an active period, and communicates with the base station.

### CROSS-REFERENCE TO RELATED APPLICATION

This application claims priority to and the benefit of Korean Patent Application No. 10-2010-0132714 filed in the Korean Intellectual Property Office on Dec. 22, 2010, the entire contents of which are incorporated herein by reference.

### BACKGROUND OF THE INVENTION

(a) Field of the Invention

The present invention relates to a base station, a terminal, and an operating method of a base station, and an operating method of a terminal. Particularly, the present invention relates to an operating method of a base station for reducing power consumption of a terminal and an operating method of a terminal.

(b) Description of the Related Art

Lately, various types of wireless communication devices have been introduced, and machine-to-machine (M2M) devices have been advanced to utilize wireless communication. Accordingly, power consumption of a wireless terminal has been receiving greater attention. Particularly, a device has been required to communicate using a battery or using energy harvested from surroundings in order to perform remote searching or remote reading in a wide area.

In order to reduce power consumption of a battery, a terminal uses a communication protocol having an idle/sleep mode. According to such a protocol, a terminal in an idle/sleep mode performs only searching of a timer for receiving or transmitting a new packet under an assumption that the terminal cannot receive/transmit packets in the idle/sleep mode.

However, a device has a limitation of communication using a battery in wireless communication, particularly in an environment including sensors. Accordingly, it is necessary to control operation of a device based on an energy level harvested from surroundings. Particularly, there is a need for developing a protocol that controls a transmitting/receiving unit to maximally reduce power consumption and operates using only energy harvested from surroundings in order to reduce battery consumption.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a communication protocol, an operating method of a base station, and an operating method of a terminal having advantages of reducing power consumption in a wireless communication network system for high/low speed data processing.

An exemplary embodiment of the present invention provides an operating method of a terminal including harvesting energy from a charging signal from a base station, receiving a first type of beacon signal when an amount of energy harvested in a beacon transmission period is greater than a predetermined amount, confirming a communication request from the first type of beacon signal, and performing communication with the base station by transiting to an active period when the communication request is confirmed.

The charging signal may be a preamble of the first type of beacon signal.

The operating method may further include transmitting an energy harvesting speed to the base station, and receiving the beacon transmission period from the base station. The beacon transmission period may be determined based on the energy harvesting speed.

The operating method may further include transmitting a sensing period to the base station. The beacon transmission period may be determined based on the energy harvesting speed and the sensing period.

The operating method may further include determining the beacon transmission period based on an energy harvesting speed.

The operating method may further include deciding the beacon transmission period based on an energy harvesting speed.

The operating method may further include confirming a QoS requested from the first type of beacon signal, and transiting a mode to a normal mode and communicating with the base station when the requested QoS is greater than a first threshold value.

The operating method may further include receiving a second type of beacon signal in the normal mode.

The transiting a mode to a normal mode may include transiting a mode to a high speed mode and communicating with the base station when the requested QoS is greater than a second threshold value, and transiting a mode to a low speed mode and communicating with the base station when the requested QoS is smaller than the second threshold value.

Another embodiment of the present invention provides a terminal including a wireless energy harvesting unit configured to harvest energy from a charging signal transmitted from a base station, a beacon signal receiver configured to receive a first type of beacon signal when an amount of energy harvested from a beacon transmission period is greater than a predetermined energy amount, and a packet transmitting/receiving unit configured to transit a mode to an active mode and communicate with the base station when a communication request is confirmed from the first type of beacon signal.

The charging signal may be a preamble of the first type of beacon signal.

The terminal may further include a mode determining unit configured to confirm a requested QoS from the first type of beacon signal and determine one of a normal mode and a low power mode as a terminal mode based on the requested QoS.

The beacon signal receiver may receive a second type of beacon signal in the normal mode.

The terminal may further include a surrounding energy harvesting unit configured to harvest energy from surroundings.

Yet another embodiment of the present invention provides an operating method of a base station, including generating a first type of beacon signal for a terminal operating in a normal mode, generating a second type of beacon signal for a terminal operating in a low power mode, generating a charging signal for a terminal operating in a low power mode, and transmitting the first type of beacon signal, the second type of beacon signal, and the charging signal.

The charging signal may be a preamble of the first type of beacon signal.

The operating method may further include determining a transmission period of the second type of beacon signal using at least one of an energy harvesting speed and a sensing period of the low power mode.

The first type of beacon signal may include information on a transition command for transiting from the normal mode of a terminal to the low power mode, and the second type of beacon signal may include information on a transition command for transiting from the low power mode of the terminal to the normal mode.

Yet another embodiment of the present invention provides a base station including a first beacon generator configured to generate a first type of beacon signal for a terminal operating in a normal mode, a second beacon generator configured to generate a second type of beacon signal for a terminal operating in a low power mode, a charging signal generator configured to generate a charging signal for a terminal operating in a low power mode, and a signal transmitter configured to transmit the first type of beacon signal, the second type of beacon signal, and the charging signal.

The charging signal may be a preamble of the first type of beacon signal.

### BRIEF DESCRIPTION OF THE DRAWINGS

FIG. 1 illustrates an operation in a sleep mode in accordance with an exemplary embodiment of the present invention.

FIG. 2 illustrates a flowchart for an operating method of a terminal, in accordance with an exemplary embodiment of the present invention.

FIG. 3 illustrates beacon signal transmission timing in accordance with an exemplary embodiment of the present invention.

FIG. 4 illustrates a low power beacon B transmission structure in accordance with an exemplary embodiment of the present invention.

FIG. 5 is a flowchart that illustrates a low power mode operation in accordance with an exemplary embodiment of the present invention.

FIG. 6 is a flowchart that illustrates an operating method of a base station in accordance with an exemplary embodiment of the present invention.

FIG. 7 is a block diagram that illustrates a base station in accordance with an exemplary embodiment of the present invention.

FIG. 8 is a flowchart that illustrates an operating method of a terminal in accordance with an exemplary embodiment of the present invention.

FIG. 9 is a block diagram that illustrates a terminal in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

In the specification, a terminal may be referred to as a sensor, a mobile station (MS), a mobile terminal (MT), a subscriber station (SS), a portable subscriber station (PSS), user equipment (UE), and an access terminal (AT). Furthermore, the terminal may include at least one of functions of a mobile station, a mobile terminal, a subscriber station, a portable subscriber station, and user equipment.

In the specification, a base station (BS) may be referred to as a coordinator, an access point (AP), a radio access station (RAS), a nodeB, a base transceiver station (BTS), and a mobile multihop relay (MMR)-BS. Furthermore, the base station (BS) may include at least one of functions of an access point (AP), a radio access station (RAS), a nodeB, a base transceiver station (BTS), and a mobile multihop relay (MMR)-BS.

Hereinafter, a base station and a terminal in accordance with an exemplary embodiment of the present invention will be described with reference to the accompanying drawings.

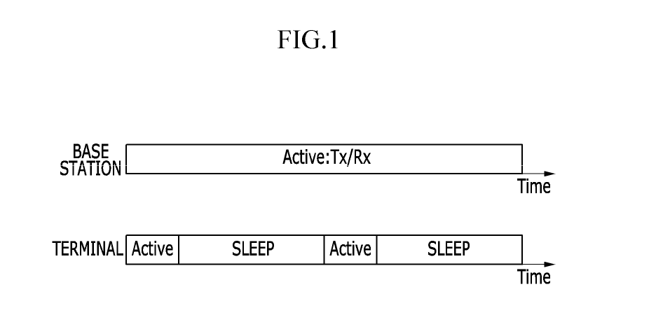

FIG. 1 illustrates an operation in a sleep mode in accordance with an exemplary embodiment of the present invention.

As shown in FIG. 1, a base station manages a network. Such a base station may operate in a mode in which the base station can always transmit and receive data. Unlike the base station, a device or a terminal may operate in one of an active mode and an idle/sleep mode. The device or the terminal may exchange data in the active mode but does not drive hardware in the idle/sleep mode. According to such an idle/sleep mode protocol, an idle/sleep mode period may be designated and a terminal or a device is restricted from exchanging packets in the idle/sleep mode. As described above, power consumption may be reduced using the idle/sleep mode but the power consumption may not be controlled in the active period.

In the active period, a single protocol must be used to transmit and receive a packet because of compatibility with other devices and frequency efficiency. However, it is not necessary to divide a mode into the active mode and the idle/sleep mode for hardware such as that which is installed at an industrial field and for a system in a commercial network such as a cellular network. Therefore, it is not necessary to realize a network always operating in a low power mode and a low speed mode and to realize a network always operating in a high power mode and a high speed mode. Particularly, a communication structure that can minimize battery consumption may be considered when it is requested to reduce battery consumption of a terminal.

Furthermore, sensors installed in an industrial field may have a structure for harvesting energy from surroundings. In this case, an energy harvesting amount may differ according to various factors such as a time of day, a time of year, or weather conditions thereof. It may be different from a protocol of a communication system, which requires a constant specification.

Therefore, there is a need for developing a communication protocol for operating a terminal with low power consumption.

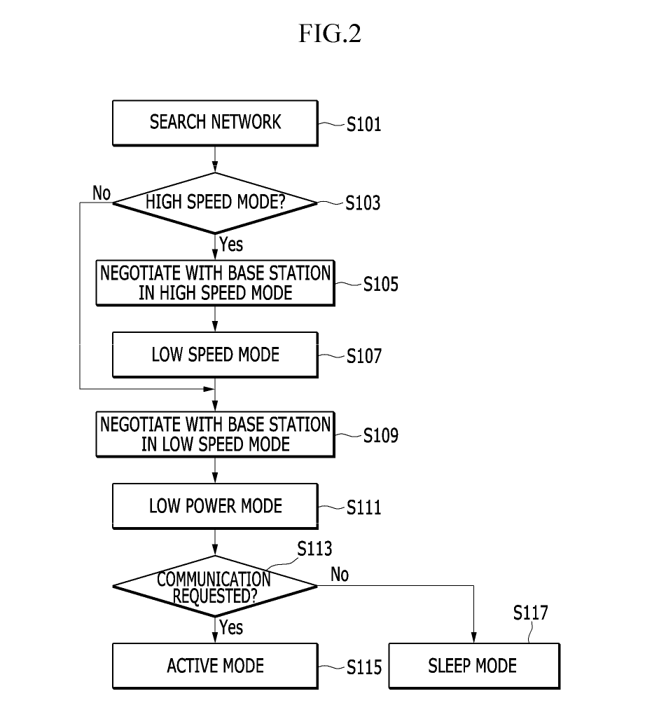

FIG. 2 is a flowchart that illustrates an operating method of a terminal, in accordance with an exemplary embodiment of the present invention.

A terminal searches for a network to access when power is supplied to the terminal at step S101.

The terminal determines whether a structure of the network is a high speed mode or a low speed mode at step S103.

When the network structure is a high speed mode and the terminal needs to transit from a high speed mode to a low speed mode, the terminal negotiates with a base station of the network in the high speed mode at step S105 and transits from the high speed mode to the low speed mode according to the negotiation result at step S107.

When the network structure is a low speed mode and the terminal needs to transit from a high power mode to a low power mode, the terminal negotiates with a base station of the network in a low speed mode at step S109 and the terminal transits from the high power mode to the low power mode according to the negotiation result at step S111.

The terminal determines whether or not packet transmission or packet reception is required in a low power mode at step S113.

When the packet transmission or the packet reception is required, the terminal enters into an active mode period and exchanges packets with the base station at step S115.

When packet transmission or packet reception is not required, the terminal enters a sleep mode period at step S117. The terminal may harvest energy from surroundings in the sleep mode period.

Since the terminal operates in the high speed mode, the low speed mode, or the low power mode, power consumption can be reduced without realizing unnecessary hardware.

In order to operate a terminal in a low power mode, a communication protocol needs to have a structure suitable for the low power mode of the terminal. Particularly, the terminal may use a simple modulation scheme such as pulse position modulation (PPM), frequency shift keying (FSK), and binary phase shift keying (BPSK), and a simple error check function in a low power mode. Since high frequency efficiency is not achieved in a low power mode, the terminal may use a low power mode in a short time period.

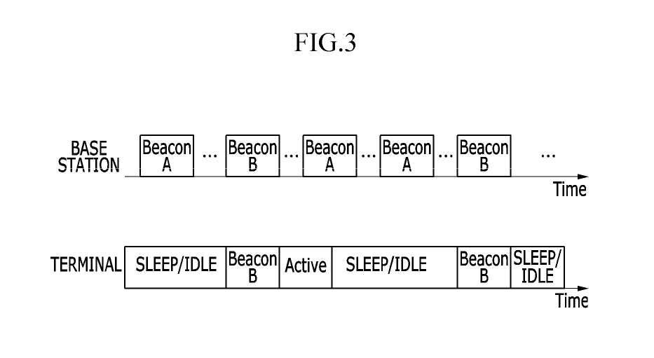

FIG. 3 illustrates transmission timing of a beacon signal, in accordance with an exemplary embodiment of the present invention. Particularly, heterogeneous beacon signals may be used to support a low power mode in FIG. 3. The beacon signal may be a signal including basic information for communication, such as system information or scheduling information of a terminal. Although the beacon signal is used in an exemplary embodiment of the present invention, the present invention is not limited thereto.

As shown in FIG. 3, the base station transmits a beacon A signal and a beacon B signal. The beacon A signal includes system information or scheduling information for a terminal operating in a normal mode. The beacon B signal indicates a low power mode. The beacon B signal includes system information or scheduling information for a terminal operating in a low power mode. For the beacon B signal, a different module scheme or a different channel code may be used compared to the beacon A signal. A terminal operating in a low power mode can determine whether a base station has a packet to be transmitted to the terminal or not by only receiving a beacon B signal. The terminal can determine a packet transmission location through the beacon B signal. Therefore, the terminal may enter into an active period for transmitting or receiving a packet after receiving the beacon B signal. As shown in FIG. 3, the active period may be adjacent to the beacon B period or separated by a regular gap from the beacon B period.

In order to only receive a beacon B signal, characteristics of the terminal may be transmitted to the base station. The terminal may transmit information to the base station about whether the terminal can operate without power or how long the terminal can operate in a sleep mode period when the terminal operates in a power mode. For example, if a terminal uses an energy harvesting function, a period for detecting a beacon signal can be varied according to an energy harvesting speed. Therefore, the terminal may report an energy harvesting speed to the base station or calculate an energy harvesting period based on an energy harvesting speed and transfer the calculated energy harvesting period to the base station. The base station may allocate a part of the beacon B period to a corresponding terminal and may perform traffic scheduling. A beacon receiving period of the terminal may be determined by an energy harvesting speed, a purpose of a terminal, and a lifespan setup of a terminal. For example, the purpose of the terminal may be a temperature sensing period, a wind direction sensing period, a water level sensing period, or a pressure sensing period. When the terminal transfers such information to the base station, the base station determines a period of receiving a beacon B signal in response to a request of the terminal and reports the determined period to the terminal.

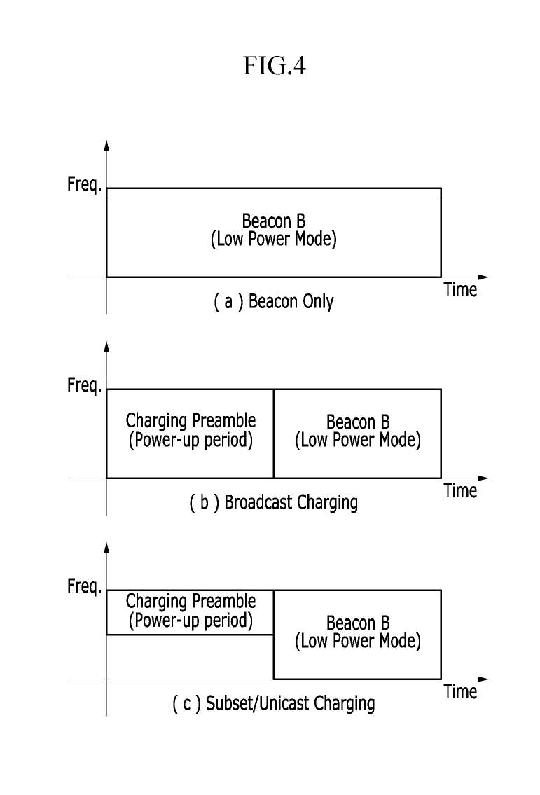

FIG. 4 illustrates a structure of a low power beacon B transmission period in accordance with an exemplary embodiment of the present invention. As shown in FIG. 4, the low power beacon B transmission period may have three structure types.

A diagram (a) of FIG. 4 illustrates a first type of a low power beacon B transmission structure. As shown in diagram (a) of FIG. 4, the first type of low power beacon B transmission structure may include only a beacon B signal modulated by a signal modulation scheme.

Diagram (b) of FIG. 4 illustrates a second type of low power beacon B transmission structure. As shown in diagram (b) of FIG. 4, the second type of low power beacon B transmission structure may include a charging preamble period and a beacon B period. A terminal harvests energy using the charging preamble period. When energy is sufficiently harvested, the terminal may receive a beacon B signal using the harvested energy. When energy is not sufficiently harvested, the terminal receives a beacon B signal using the harvested energy and energy from a battery.

Diagram (c) of FIG. 4 illustrates a third type of a low power beacon B transmission period. As shown in diagram (c) of FIG. 4, the third type of low power beacon B transmission period may include a charging preamble period and a beacon b signal period. In the third type of low power beacon B transmission structure, a base station concentrates power to a predetermined terminal or a predetermined terminal group rather than distributing power to all terminals. For this purpose, a base station may transmit a charging preamble signal by concentrating power to a narrow band. Furthermore, a base station can transmit a charging preamble by using beam-forming. In order to transmit the charging preamble, a frequency in a communication band can be used. In order to avoid interference, a frequency that is different from the communication band can be used. The terminal receives a charging preamble and receives a beacon B signal by harvesting energy from the charging preamble. The terminal may determine a location of a beacon B by confirming a specific frequency bandwidth at a specific time offset location at a specific period.

In order to support an energy charging preamble, a base station may instruct a specific terminal to harvest specific energy only. Particularly, the base station informs the terminal of an energy harvesting period by designating a frequency or a time period. The terminal may not receive a beacon B signal when energy is not sufficiently harvested. When a terminal receives a message after sufficiently harvesting energy and reading a beacon B signal, the terminal may transmit a response to the base station in response to the received beacon B signal.

The base station may transmit a charging preamble in a time period that is different from a time period where a beacon packet is transmitted. The base station can overlap a charge preamble signal at a time period where a beacon packet exists. The charging preamble performs power charging for terminal processing. The charging preamble may occupy a predetermined period on a frequency domain or may be disposed on a time domain while being interlaced with a beacon packet. The base station may apply power-boosting to the charging preamble. When a terminal does not need energy harvesting from the charging preamble, the terminal uses the charging preamble for channel estimation or for signal synchronization.

Meanwhile, the charging preamble is not dependent on a beacon. The charging preamble may be transmitted always or according to a rule.

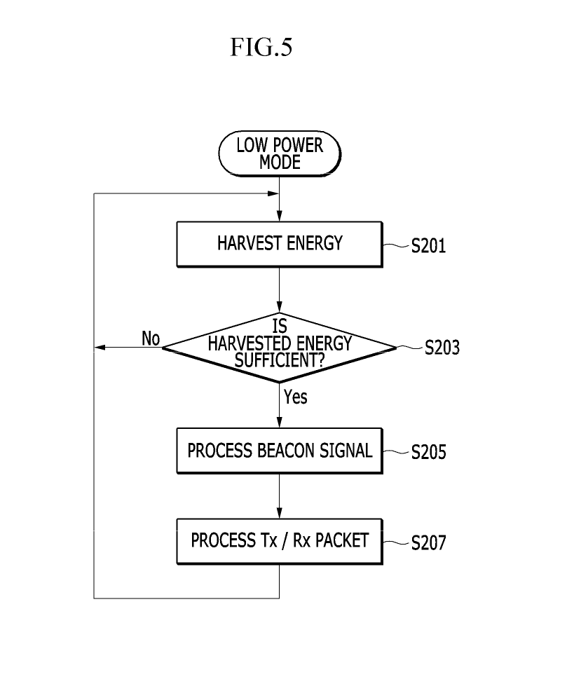

FIG. 5 is a flowchart that illustrates a low power mode operation of a terminal, in accordance with an exemplary embodiment of the present invention.

A terminal may harvest energy from surroundings or from a charging preamble in a sleep period of a low power mode at step S201. The terminal may harvest energy only from surroundings or only from a charging preamble. The terminal may harvest energy from both of surroundings and a charging preamble. Particularly, the terminal may harvest energy only from the charging preamble in order to enable a base station to further efficiently control the terminal.

The terminal determines whether the harvested energy is greater than a predetermined energy level at step S203. When the harvested energy is not greater than the predetermined energy level, the terminal continually performs the energy harvesting operation.

When the harvested energy is greater than the predetermined energy level, the terminal receives a beacon packet using the harvested energy and obtains scheduling information or system information at step S205.

The terminal determines a request of packet transmission or a request of packet reception based on the obtained scheduling information or system information. When the packet transmission or the packet reception is requested, the terminal enters an active period and exchanges packets with the base station at step S207. When the packet transmission or the packet reception is not requested, the terminal enters a sleep period and harvests energy from surroundings.

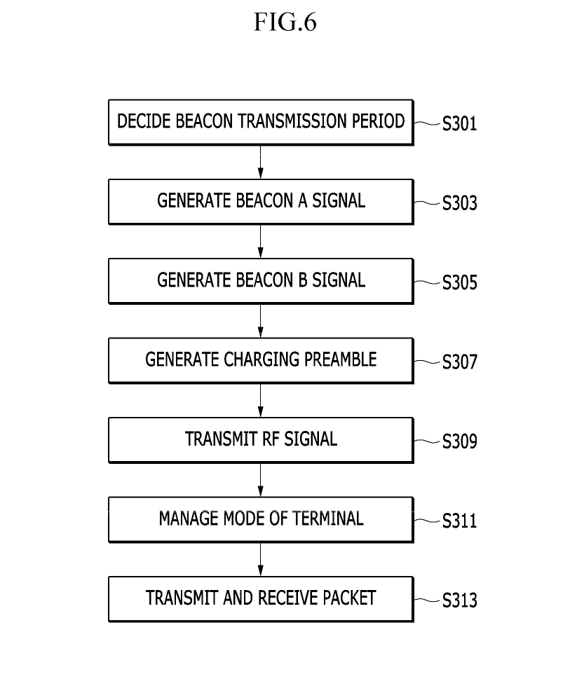

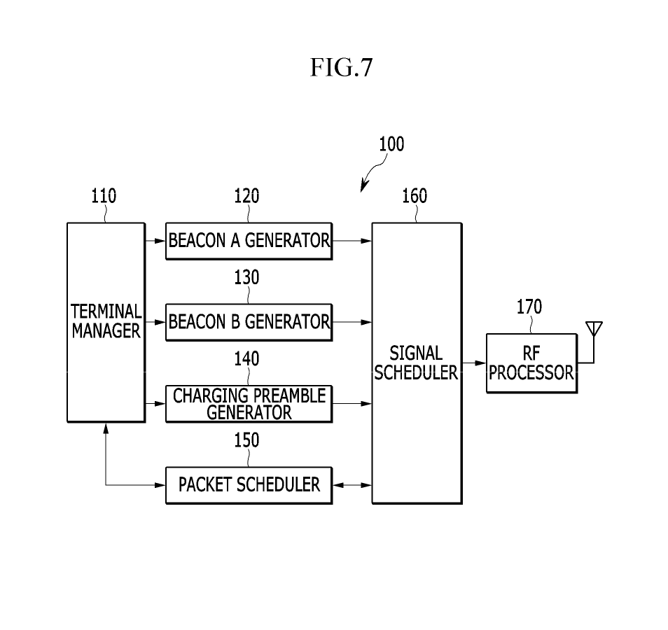

A base station in accordance with an exemplary embodiment of the present invention will be described with reference to FIG. 6 and FIG. 7.

FIG. 6 is a flowchart that illustrates an operation method of a base station in accordance with an exemplary embodiment of the present invention.

A base station determines an energy harvesting speed of a terminal, a purpose of a terminal, a beacon A transmission period according to a lifespan of a terminal, a beacon B transmission period, and a charging preamble transmission period at step S301. The base station may manage the energy harvesting speed of the terminal, the purpose of the terminal, and the lifespan setup of the terminal or receive such information from the terminal. The base station may notify the terminal of the beacon A transmission period, the beacon B transmission period, and the charging preamble transmission period. When the beacon B and the charging preamble are transmitted as shown in diagrams (b) and (c) of FIG. 4, the charging preamble period may be identical to the beacon B transmission period. The base station may receive the beacon A transmission period, the beacon B transmission period, and the charging preamble transmission period from the terminal.

The base station generates a beacon A signal for a terminal in a normal mode such as a high speed mode or a low speed mode at step S303, and generates a beacon B signal for a terminal in a low power mode at step S305.

The base station may transmit a communication request to the terminal through the beacon A signal or the beacon B signal in order to enable the terminal to enter an active period and communicate with the base station. Particularly, the base station informs the terminal of a downlink packet to be transmitted through the beacon A signal or the beacon B signal. Accordingly, the terminal enters an active period and can receive the downlink packet from the base station.

The base station may command the terminal for mode transition according to a requested QoS through a beacon A signal or a beacon B signal. For example, the base station may command the terminal to transit from a high speed mode to a low speed mode through a beacon A signal when a request QoS for a terminal operating in a high speed mode is lower than a first threshold value TH1. The requested QoS for a terminal may be determined according to a downlink packet amount and a data rate of a corresponding terminal. When the request QoS for a terminal operating in a low speed mode is smaller than a second threshold value TH2, the base station may command a terminal to transit from a high power mode to a low power mode through a beacon A signal. When a requested QoS for a terminal operating in a low power mode is greater than a second threshold value TH2, the base station may command a terminal to transit from a high speed mode to a low speed mode through a beacon B signal. When the requested QoS for a terminal operating in a low speed mode is greater than the first threshold value TH1, the base station may command the terminal to transit from a low speed mode to a high speed mode through a beacon A signal.

The base station generates a charging preamble for a terminal in a low power mode at step S307.

The base station transmits a beacon A signal according to a beacon A transmission period, transmits a beacon B signal according to a beacon B transmission period, and transmits a charging preamble according to a transmission period of the charging preamble at step S309.

The base station manages a mode of the terminal at step S311. Particularly, the base station manages a mode of a terminal based on a mode corresponding to a mode transition notification message when the base station receives the mode transition notification message from the terminal. Also, when the base station commands the terminal to perform mode transition through the beacon A signal or the beacon B signal, the base station manages the mode of the terminal based on the corresponding commanded mode.

The base station exchanges a packet with the terminal according to a communication protocol for a negotiated terminal mode at step S313.

FIG. 7 is a block diagram that illustrates a base station in accordance with an exemplary embodiment of the present invention. Particularly, FIG. 7 illustrates a structure of a base station that transmits a signal, for example, a beacon B signal, in order to support a low power mode of a terminal. The base station of FIG. 7 may perform a communication method of FIG. 6.

As shown in FIG. 7, the base station 100 in accordance with an exemplary embodiment of the present invention may include a terminal manager 110, a beacon A generator 120, a beacon B generator 130, a charging preamble generator 140, a packet scheduler 150, and an RF processor 160.

The terminal manager 110 manages a mode of a terminal and a downlink packet for the terminal.

The beacon A generator 120 generates a beacon A signal using system information for a terminal in a normal mode such as a high speed mode or a low speed mode. The beacon B generator 130 generates a beacon B signal using system information for a terminal in a low power mode. The charging preamble generator 140 generates a charging preamble using a power stream for a terminal in a low power mode.

The packet scheduler 150 determines a transmission time of a downlink packet and a receiving time of an uplink packet. The signal scheduler 160 determines a time/frequency response to transmit a beacon A signal, a beacon B signal, a charging preamble, and packet traffic. The RF processor 170 performs RF processing for the beacon A signal, the beacon B signal, the charging preamble, and the packet. The RF processor 170 may transmit a charging preamble using a transmission power greater than that for a beacon A signal or a beacon B signal. The RF processor 170 may perform beam-forming for the charging preamble.

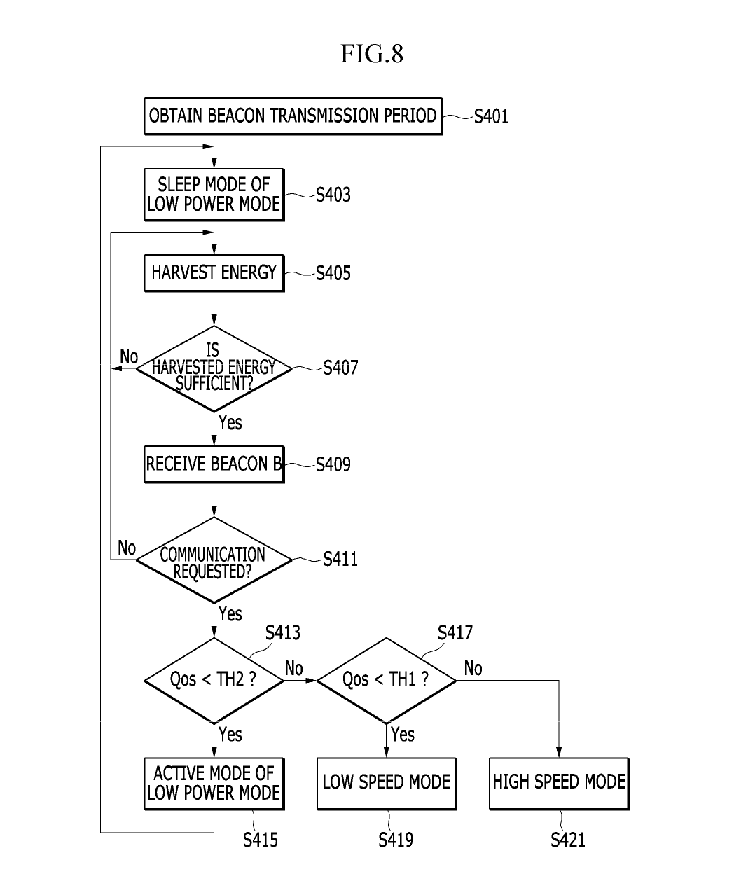

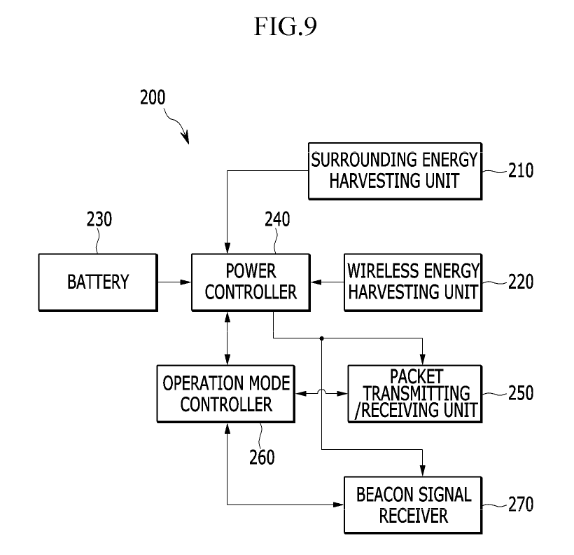

Hereinafter, a terminal in accordance with an embodiment of the present invention will be described with reference to FIG. 8 and FIG. 9.

FIG. 8 is a flowchart that illustrates an operation method of a terminal in accordance with an exemplary embodiment of the present invention.

A terminal obtains a beacon A transmission period, a beacon B transmission period, a charging preamble transmission period at step S401. The terminal may determine a transmission period according to an energy harvesting speed, a purpose of the terminal, and a lifespan setup of the terminal. The terminal may provide the energy harvesting speed, the purpose of the terminal, and the lifespan setup of the terminal to the base station. The base station may determine a transmission period based on the received information from the terminal. Then, the terminal may receive the determined transmission period from the base station.

For better comprehension and ease of description, the terminal may be in a sleep mode of a low power mode at step S403.

The terminal harvests energy from surroundings or a charging preamble in a sleep mode of a low power mode at step S405.

The terminal determines whether or not the amount of energy harvested from a beacon B transmission period is sufficient at step S407.

When the harvested energy amount is smaller than a threshold, the terminal continuously harvests energy or receives a beacon B signal using energy of a battery.

When the harvested energy amount is greater than a threshold, the terminal receives a beacon B signal using the harvested energy at step S409.

The terminal determines whether or not there is a request of communication with the base station through beacon B at step S411.

When there is no request of communication with the base station, the terminal continuously harvests energy and waits for a next beacon B transmission period.

When there is a request of communication with a base station, the terminal determines whether a requested QoS for communicating with the base station through the beacon B is greater than a second threshold value TH2 at step S413.

When the requested QoS is smaller than the second threshold value TH2, the terminal enters into an active period of a low power mode and communicates with the base station at step S415.

When the requested QoS is greater than the second threshold value TH2, the terminal may transit to a normal mode. For this purpose, the terminal determines whether the requested QoS is greater than the first threshold value TH1 at step S417.

When the requested QoS is smaller than the second threshold value TH2, the terminal transits to a low power mode and communicates with the base station at step S419.

When the requested QoS is greater than the second threshold value TH2, the terminal transits to a high speed mode and communicates with the base station at step S421.

FIG. 9 is a block diagram that illustrates a terminal in accordance with an exemplary embodiment of the present invention. The terminal of FIG. 9 can perform the communication method of FIG. 8.

As shown in FIG. 9, the terminal 200 in accordance with an exemplary embodiment of the present invention may include a surrounding energy harvesting unit 210, a wireless energy harvesting unit 220, a battery 230, a power controller 240, a packet transmitting/receiving unit 250, an operation mode controller 260, and a beacon signal receiver.

The surrounding energy harvesting unit 210 harvests energy from surroundings. The wireless energy harvesting unit 220 harvests energy from a charging preamble.

The operation mode controller 260 determines an operation mode of a terminal and informs the determined operation mode to the power controller 240, the packet transmitting/receiving unit 250, and the beacon signal receiver 270 to enable the terminal to operate in the determined operation mode.

The power controller 240 measures the harvested energy amount and determines whether to use the harvested energy or the energy of the battery. The power controller 240 provides power to the packet transmitting/receiving unit 250 and the beacon signal receiver 270.

According to an exemplary embodiment of the present invention, the base station simultaneously supports a terminal in a high speed mode, a terminal in a low speed mode, and a terminal in a low power mode. The terminal in a low power mode can operate with low power or without power.

The apparatus and method according to an exemplary embodiment of the present invention described above can be realized as a program performing functions corresponding to configuration elements of the apparatus and method or as a computer readable recording medium storing the program. Since the realization can be easily implemented by those skilled in the art to which the exemplary embodiment of the present invention pertains, further description will not be provided herein.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An operating method of a terminal, comprising:
harvesting energy from a charging signal from a base station;
receiving a first type of beacon signal when an amount of energy harvested in a beacon transmission period is greater than a predetermined amount;
confirming a communication request from the first type of beacon signal; and
performing communication with the base station by transiting to an active period when the communication request is confirmed.

2. The operating method of claim 1, wherein the charging signal is a preamble of the first type of beacon signal.

3. The operating method of claim 2, further comprising:
transmitting an energy harvesting speed to the base station; and
receiving the beacon transmission period from the base station,
wherein the beacon transmission period is determined based on the energy harvesting speed.

4. The operating method of claim 3, further comprising
transmitting a sensing period to the base station,
wherein the beacon transmission period is determined based on the energy harvesting speed and the sensing period.

5. The operating method of claim 2, further comprising
determining the beacon transmission period based on an energy harvesting speed.

6. The operating method of claim 5, wherein the determining the beacon transmission period includes determining the beacon transmission period based on a sensing period.

7. The operating method of claim 2, further comprising:
confirming a QoS requested from the first type of beacon signal; and
transiting a mode to a normal mode and communicating with the base station when the requested QoS is greater than a first threshold value.

8. The operating method of claim 7, further comprising
receiving a second type of beacon signal in the normal mode.

9. The operating method of claim 7, wherein the transiting a mode to a normal mode includes:
transiting a mode to a high speed mode and communicating with the base station when the requested QoS is greater than a second threshold value; and
transiting a mode to a low speed mode and communicating with the base station when the requested QoS is smaller than the second threshold value.

10. A terminal comprising:
a wireless energy harvesting unit configured to harvest energy from a charging signal transmitted from a base station;
a beacon signal receiver configured to receive a first type of beacon signal when an amount of energy harvested from a beacon transmission period is greater than a predetermined energy amount; and
a packet transmitting/receiving unit configured to transit a mode to an active mode and communicate with the base station when a communication request is confirmed from the first type of beacon signal.

11. The terminal of claim 10, wherein the charging signal is a preamble of the first type of beacon signal.

12. The terminal of claim 11, further comprising
a mode determining unit configured to confirm a requested QoS from the first type of beacon signal and determine one of a normal mode and a low power mode as a terminal mode based on the requested QoS.

13. The terminal of claim 12, wherein the beacon signal receiver receives a second type of beacon signal in the normal mode.

14. The terminal of claim 11, further comprising a surrounding energy harvesting unit configured to harvest energy from surroundings.

15. An operating method of a base station, comprising:
generating a first type of beacon signal for a terminal operating in a normal mode;
generating a second type of beacon signal for a terminal operating in a low power mode;
generating a charging signal for a terminal operating in a low power mode; and
transmitting the first type of beacon signal, the second type of beacon signal, and the charging signal.

16. The operating method of claim 15, wherein the charging signal is a preamble of the first type of beacon signal.

17. The operating method of claim 16, further comprising
determining a transmission period of the second type of beacon signal using at least one of an energy harvesting speed and a sensing period of the low power mode.

18. The operating method of claim 17, wherein the first type of beacon signal includes information on a transition command for transiting from the normal mode of a terminal to the low power mode, and
the second type of beacon signal includes information on a transition command for transiting from the low power mode of the terminal to the normal mode.

19. A base station comprising:
a first beacon generator configured to generate a first type of beacon signal for a terminal operating in a normal mode;
a second beacon generator configured to generate a second type of beacon signal for a terminal operating in a low power mode;
a charging signal generator configured to generate a charging signal for a terminal operating in a low power mode; and
a signal transmitter configured to transmit the first type of beacon signal, the second type of beacon signal, and the charging signal.

20. The base station of claim 19, wherein the charging signal is a preamble of the first type of beacon signal.
